(19) United States
(12) Patent Application Publication
(10) Pub. No.: US 2013/0179400 A1
(43) Pub. Date: Jul. 11, 2013

(54) INTELLIGENT DATA PUBLISHING FRAMEWORK FOR COMMON DATA UPDATES IN LARGE SCALE NETWORKS OF HETEROGENEOUS COMPUTER SYSTEMS

(71) Applicants: Mohamed E. Daly, Palisades Park, NJ (US); Raghu Ram Kunde, Keyport, NJ (US)

(72) Inventors: Mohamed E. Daly, Palisades Park, NJ (US); Raghu Ram Kunde, Keyport, NJ (US)

(73) Assignee: MORGAN STANLEY, New York, NY (US)

(21) Appl. No.: 13/346,494

(22) Filed: Jan. 9, 2012

(51) Int. Cl. G06F 7/00; G06F 17/00

(52) U.S. Cl. 707/631; 707/E17.005

(57) ABSTRACT

A computerized data publishing method in which an action is received from a source. The action results in a data state change that must be propagated to multiple heterogeneous computer devices, in a manner that maintains the consistency of data among multiple heterogeneous computer devices. A record is saved in storage reflecting the data state change. The update process updates the impacted computer devices with the modified data using a publishing mechanism, and receives an indicator of whether the updating succeeded or failed. If the updating failed, a retry of the updating is initiated using the publishing mechanism. If all the updating of all of the impacted computer devices succeeded, the operation ends.

### BACKGROUND

1. Field

This disclosure relates generally to large scale networked computing systems, and, more particularly, to data updates in large scale computing systems.

2. Background

When managing a large group of computer systems, such as complex data systems used in the financial industry, for example, large quantities of time critical interrelated data may be spread over a large number of disparate systems. In many cases, a change to data on one system may impact related or dependent information and processes on other computers within the system. Therefore, this change must be communicated to the other client systems to maintain consistency among the disparate systems, but the often-heterogeneous nature of the external client systems will generally not allow the change to be propagated to all relevant computers in the system in the same way or with the same format. This may not present an issue to administration of small scale computer system groups, but with sufficiently large computer systems groups (populated by, for example, dozens of computer systems), it poses a daunting problem. The lack of uniformity typically means that the system must be able to handle multiple communication methods, protocols, formats, etc., yet still update in a timely fashion. For example, some external systems may update using real-time notifications, while others will require batch notifications at certain intervals. Some external systems may require receiving the change as a parcel update, while others may require a full refresh of not only the changed information but also all related data. Some systems may wait passively for updates, while others may actively query a managing system on a regular basis for changes. Moreover, formatting and language may be varied among the disparate systems.

The above creates a problem with regard to ensuring delivery and synchronization of the information among all impacted systems. Traditionally, because of the criticality and inter-related nature of the information making up the update data, update operations are performed atomically, which requires all update operations to complete successfully for a change to take effect. If even a single update operation on any computer fails to complete successfully, the data update operation must be rolled back entirely for all the impacted systems, resulting in huge time and resource inefficiencies, and the entire operation must be reattempted. Compounding this issue is the fact the failure may have been due to a minor and/or temporary issue. For example, one or more computers may have been temporarily offline or unavailable due to technical issues that can be resolved or corrected within an acceptable period of time. By way of specific example, a single external client system may have been in the midst of rebooting when the update was attempted, or may have been offline briefly for maintenance during off-hours in a location where the update delay will have little to no impact.

### BRIEF SUMMARY

In one aspect of this disclosure, a computerized method of implementing an intelligent data publisher is disclosed. A first set of steps is performed as an atomic operation. The first set of steps includes receiving an action from a source, at a computer, the action resulting in a data state change, the data state change being of a type which must be propagated to multiple heterogeneous computer devices, wherein consistency of data impacted by the data state change is to be maintained among all of the multiple heterogeneous computer devices. The first set of steps also includes saving a record in storage, associated with the computer, reflecting the data state change, the record containing information usable by at least one update process to update impacted computer devices from among the multiple heterogeneous computer devices to reflect the data state change. Control is returned to the source. If the atomic operation completes, then a second set of steps is performed as a non-atomic operation. The second set of steps includes invoking, using the computer, the at least one update process to perform modifying the data into a configuration for compatibility with the impacted computer devices based upon contents of the record, updating the impacted computer devices with the modified data using a publishing mechanism, and receiving from the publishing mechanism, for each of the impacted computer devices, an indicator of whether the updating succeeded or failed. If the updating failed, a retry of the updating is initiated using the publishing mechanism. If all the updating of all of the impacted computer devices succeeded, the non-atomic operation is ended.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is a high level representation showing the propagation of an event of interest through a complex system without the use of an example intelligent data publisher;

FIG. 2 is a high level representation of an example intelligent data publisher comprising an update handler system and a publisher/scheduling system;

FIG. 3 is a functional figure broadly describing the overall process flow of the intelligent data publishing system of FIG. 2;

FIG. 4 is a flow chart representing a continuing sequence of steps for implementing the intelligent data publishing system of FIG. 2;

FIG. 5 is a flow chart representing a continuing sequence of steps for implementing the intelligent data publishing system of FIG. 2;

FIG. 6 is a flow chart representing a continuing sequence of steps for implementing the intelligent data publishing system of FIG. 2;

FIG. 7 is a flow chart representing a continuing sequence of steps for implementing the intelligent data publishing using the system of FIG. 2;

FIG. 8 is a flow chart representing a continuing sequence of steps for implementing the intelligent data publishing using the system of FIG. 2;

FIG. 9 is a flow chart representing a continuing sequence of steps for implementing the intelligent data publishing using the system of FIG. 2; and

FIG. 10 is a flow chart representing a continuing sequence of steps for implementing the intelligent data publishing using the system of FIG. 2.

### DETAILED DESCRIPTION

In high-level overview, a computer-implemented method and system is disclosed for propagating a critical data update across multiple heterogeneous computers resulting from a data change (hereafter referred to as an “event of interest”) in a manner that maintains data content consistency among the impacted heterogeneous computers without causing a complete rollback when there is a minor failure that prevents a small piece of the system from being timely updated.

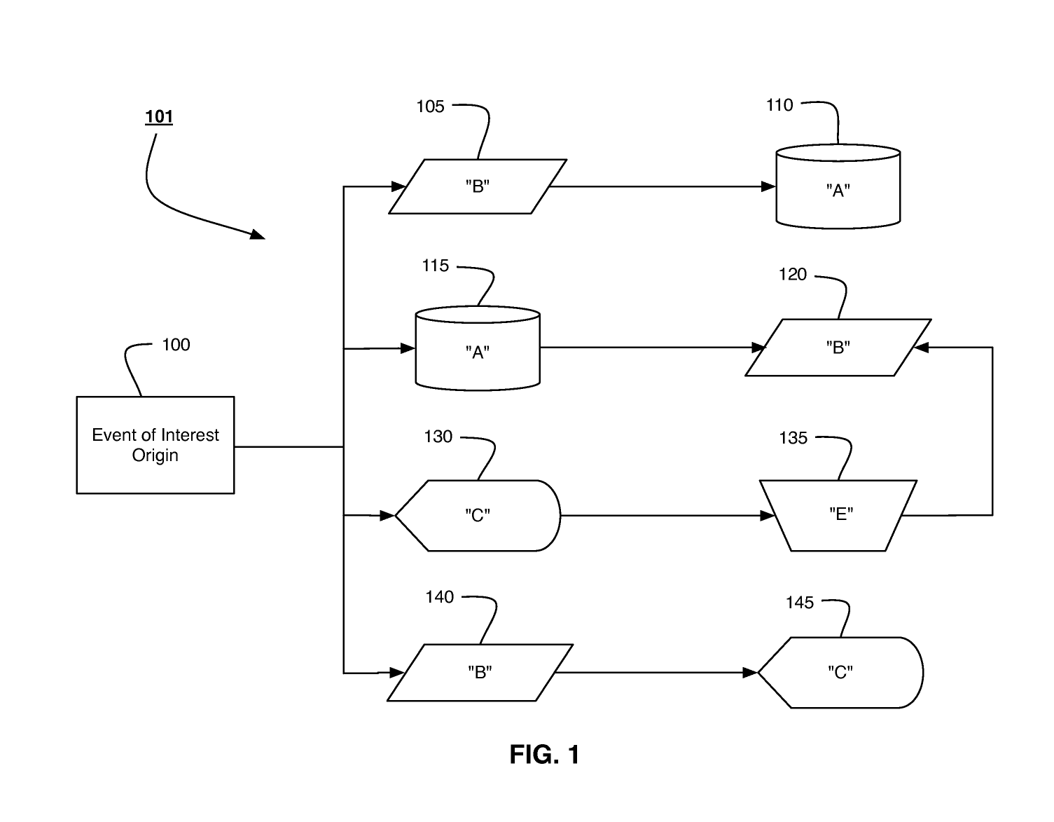

FIG. 1 is a high level representation showing the propagation of an event of interest on system 100 through a complex system 101 without the use of an example intelligent data publisher. The complex system 101 is composed of heterogeneous mix of computer system groups 105-145. Each group represents a block of computer systems that require a different combination of data change format and delivery. For example, as shown, the computer system groups 105, 120, 140 may require parcel delivery of update data using a first format (referred to here as requirement set “B”). Two other computer system groups 110, 115 may require updates to be delivered only upon request, and require a second, different format for the update data (referred to as “A”). Another two computer system groups 130, 145 demand a third set of such format and delivery requirements (referred to as requirement set “C”), and computer system group 135 demand a fourth set of format and delivery requirements (referred to as requirement set “E”).

No central mechanism exists to coordinate the propagation of an event of interest occurring on system 100 through the complex system 101. Therefore, an individual system group may not only receive an update, but may also be responsible for sending the update data to another system group that requires the update data. For example, as shown, system group 105 is responsible for sending update data to system group 110. Because system group 110 receives update data as “A,” and system group 105 receives update data as “B,” system group 105 is responsible for converting the update data format from a format used by “B” to a format consistent with “A,” and using a delivery method consistent with the delivery requirements of “A.” A similar situation exists with respect to all the other system groups of FIG. 1. Likewise, system group 120 actually receives its updates from either system group 115, system group 135 or both, depending upon the update. Thus, system group 115 must convert “A” to “B” and system group 135 must convert “E” to “B” in order to deliver update data in a manner consistent with “B” for system group 120, system group 130 must convert “C” to “E” to deliver update data in a manner consistent with “E” to system group 135, etc.

In the depicted example, when an event of interest occurs on system 100, system 100 must convert the update data into formats “B” for system groups 105 and 140, “A” for system group 115, “C” for system group 130, and use delivery methods appropriate to “B” for system group 105, “A” for system group 115, “C” for system group 130 and “B” for system group 140. These system groups in turn must perform the same function with respect to a second set of system groups dependent upon them.

If any single data update fails in any one of these groups, all system groups must be rolled back to their pre-update respective states (i.e., prior to the propagation of the initial event of interest from system 100 to them). Because of the complexity and length of the data update process (as described above), this is inefficient and time consuming, as performing the data update successfully will require re-performing the entire process across the entire complex system 101.

To compound this difficulty, certain system groups may prove difficult to rollback successfully, as it may be unclear which state they are to revert to, especially for system 100 in which the single event of interest caused multiple subsequent events of interest updates (such as system group 120), due to factors such as the complex relationships within the complex system 101, or time lag in transmitting, receiving and applying the data updates. Furthermore, each individual system group is responsible for processing the data update to a format, content or richness digestible by its own dependent systems, in addition to utilizing the appropriate method of delivery so the event of interest is receivable by the dependent system (as described above). This creates redundant work, adding to the inefficiency of the process, and magnifying the amount of work that needs to be re-performed when the data update fails.

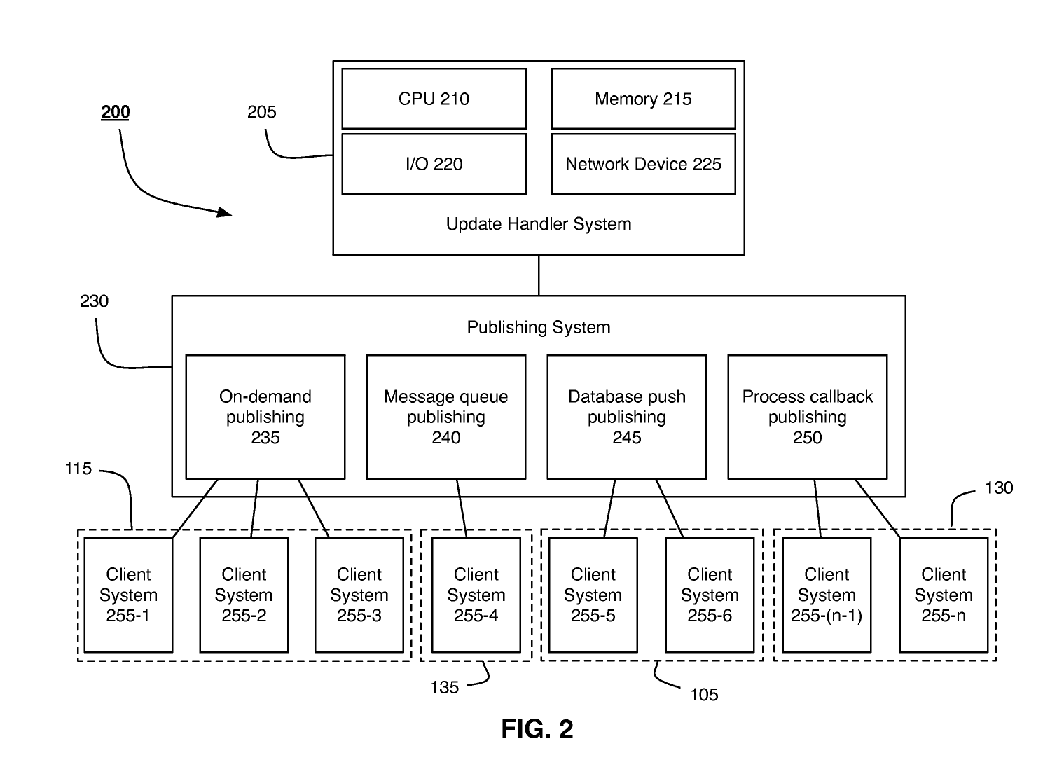

FIG. 2 is a high level representation of an example intelligent data publisher 200. The intelligent data publisher 200 comprises an update handler system 205 and a publisher/scheduling system 230. The update handler system 205 manages the runtime environment for the intelligent data publisher 200 by monitoring for, and/or receiving, actions/tasks that must be propagated to multiple heterogeneous client systems 255-1, 255-2, 255-3, 255-4, 255-5, 255-6, 255-(n-1) and 255-n. For purposes of explanation, client system 255-1, 255-2, 255-3 correspond to computers in system group 115, client systems 255-4 correspond to computers in system group 135, client systems 255-5, 255-6 correspond to computers in system group 105, and client systems 255-(n-1), 255-n correspond to computers in system group 130. For example, the update handler system 205 may listen for changes in financial information that must be propagated to external client systems housing affected financial data. Alternatively, a user may manually notify the intelligent data publisher 200 of an event of interest.

The example publishing system 230 has four separate publishing mechanisms available to effect updating of the external client systems. These are on-demand publishing 235, message queue publishing 240, database push publishing 245 and process callback publishing 250. These publishing mechanisms are known in the art and, thus, will be described here only briefly for clarity. Other publishing mechanisms may be utilized as desired, and it is understood that the ones discussed herein are for illustrative purposes only.

On-demand publishing 235 is a passive publishing process. The record is stored on the publisher/scheduling system 230, which then waits passively for requests from the external client systems. The external client systems send update requests to the publisher/scheduling system 230. In response, the record is forwarded to the external client systems.

Message queue publishing 240 utilizes a message queue to effect updating of external systems (as the name suggests). Once the publisher/scheduling system 230 receives the record, it places the record on a message queue. External client systems read messages addressed to them off the queue and retrieve the record from the message. After applying the record, the external client systems place a message on the queue indicating to the publisher/scheduling system 230 whether the update operation completed successfully or failed.

Database push publishing 245 is generally utilized in situations where the external client systems are database servers. Once the publisher/scheduling system 230 receives the record, it communicates directly to each external client system and invokes the appropriate database commands to effect the update on the external client system with the record. The publisher/scheduling system 230 then records whether the update operation succeeded or failed.

Process callback publishing 250 relies on update processes already extant on the external client systems. Once the publisher/scheduling system 230 receives the record, it invokes an update process local to the external client system and feeds the record to the process. The process then effects the update on the external client system and reports success or failure back to the publisher/scheduling system 230.

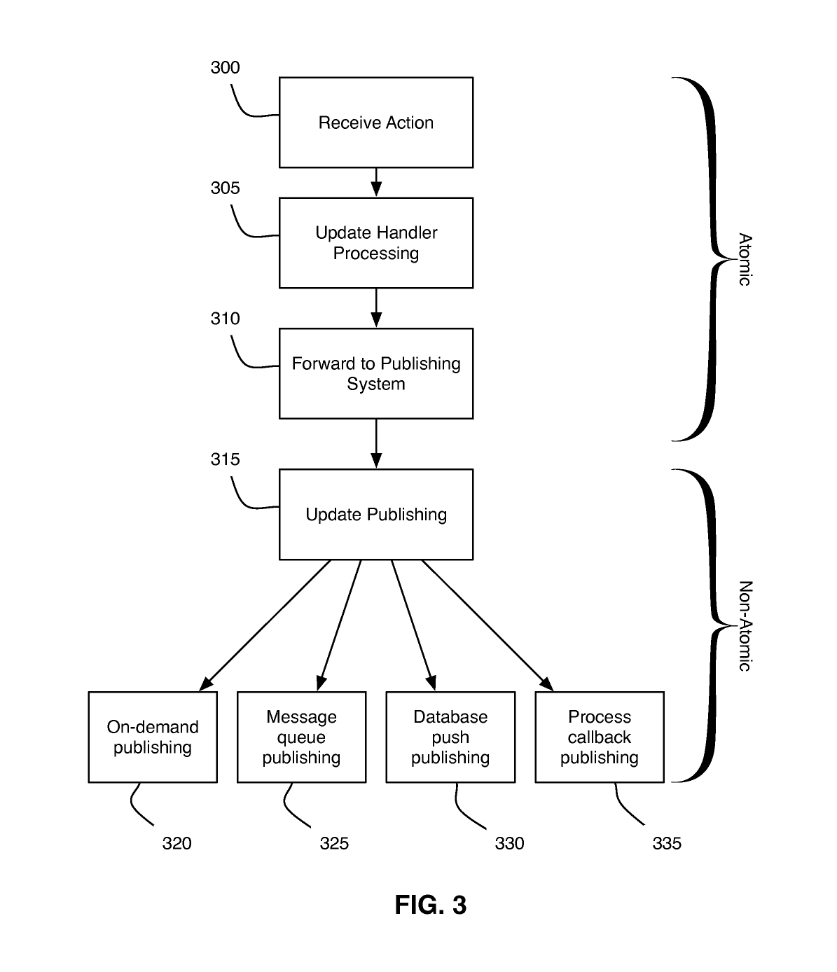

FIG. 3 is a functional figure broadly describing the overall process flow of the intelligent data publishing system 200 of FIG. 2. At its highest level of abstraction, the update process flow is divided into two process sections. The first process section is performed atomically to ensure that the entire first process section is completed successfully, and is tasked with detecting and processing events of interest that require data to be propagated down to the external client systems. Performing the first process atomically guarantees that a record of the event of interest is created and communicated to the publisher/scheduling system 230. If it is not, the update process in the origin system is “rolled-back” and the update process is cancelled entirely, thereby maintaining state consistency between the affected systems. The second process section is performed non-atomically, and involves applying the update to the external client systems using one or more of the publishing mechanisms. Notably, the second process section is invoked only when the first process section completes successfully. Because the second process section is performed non-atomically, a failure to timely update one part of the external client systems can be retried (rather than rolling-back the update for all implicated external client systems). This ensures that the update will never be rolled back on a large number of external client systems because of the failure of the update to complete on a small segment of the external client systems, particularly due to a temporary situation that is easily resolved.

Initially, the intelligent data publishing system 200 receives an event of interest that must be propagated from the origin system 100 to a set of external client systems (step 300). Once the event of interest is received, the update handler system 200 processes the event by making a record of the event, effectively scheduling the event for processing (step 305). The record is then forwarded to the publisher system 200 (step 310) in preparation for updating the external client systems. As mentioned above, if any of the previous steps fail to complete successfully, the origin system 100 is rolled-back and the update is cancelled entirely.

The record is what will be used to propagate the event to the external client systems. The actual content of the record depends on the type of event and the manner of implementation. For example, if the event is notification of a change in certain financial information, and the change must be propagated to external client systems, the record may contain the change in data so that, once read, the update may be applied automatically to the external client systems. Alternatively, the record may simply contain a notice of the change and where it is discoverable on (for example) a file server. Once the external client systems receive notice of the change through the update, they may query the server directly to download the changed data, using the identifying information as provided by the record.

The publisher/scheduling system 230, upon receiving the record, then invokes one or more publishing mechanisms to effect the update process on the external client systems (step 315). Publishing mechanisms are used because of the heterogeneous nature of the external client systems and the ability to retry a failure. There are multiple different types of publishing mechanisms, and, depending upon the particular external client systems that make up a particular environment, selecting the specific publishing mechanisms to be used in a given environment will be a function of the external client systems.

As described above, the example publishing system 230 has four separate publishing mechanisms available to effect updating of the external client systems, including on-demand publishing 320, message queue publishing 325, database push publishing 330 and process callback publishing 335. It is understood that other types of publishing mechanisms may be used, and the publishing mechanisms described herein are illustrative, and not intended to be limiting.

Thus, regardless of which publishing mechanism is used, the information is transformed, reformatted and/or enriched by the publishing system 230. Different external client systems differ regarding the update data they can receive in terms of the format, structure or content of the update data. Therefore, the update may need to be processed for use or recognition by a specific external client system. For example, certain external computer systems may require the data in a specific format, or informational metadata, such as “tags,” “headers,” or “footers” may be required. Therefore, the publishing system 230 transforms, reformats and/or enriches the data as required for each specific external client system by, for example, adding the appropriate metadata to the update or converting the update data into an appropriate format using, for example, any known method including a table storing specific format, structure, encryption scheme or content translation information for each external system.

Once the update information has been translated and the proper delivery method selected, it may be published to the receiving external client systems. The external client systems then report the success or failure of the operation back to the publisher/scheduling system 230. If any update operation fails, the publisher/scheduling system 230 initiates retries of the update operation. The update operation may be reattempted as many times as desired. For example, update operation retries may be set to continue until a certain number of retries have been attempted, or until a certain amount of time has passed. Once this threshold is reached, the publisher/scheduling system 230 may report the failure of the update so that an appropriate party (such as a human administrator) may intervene.

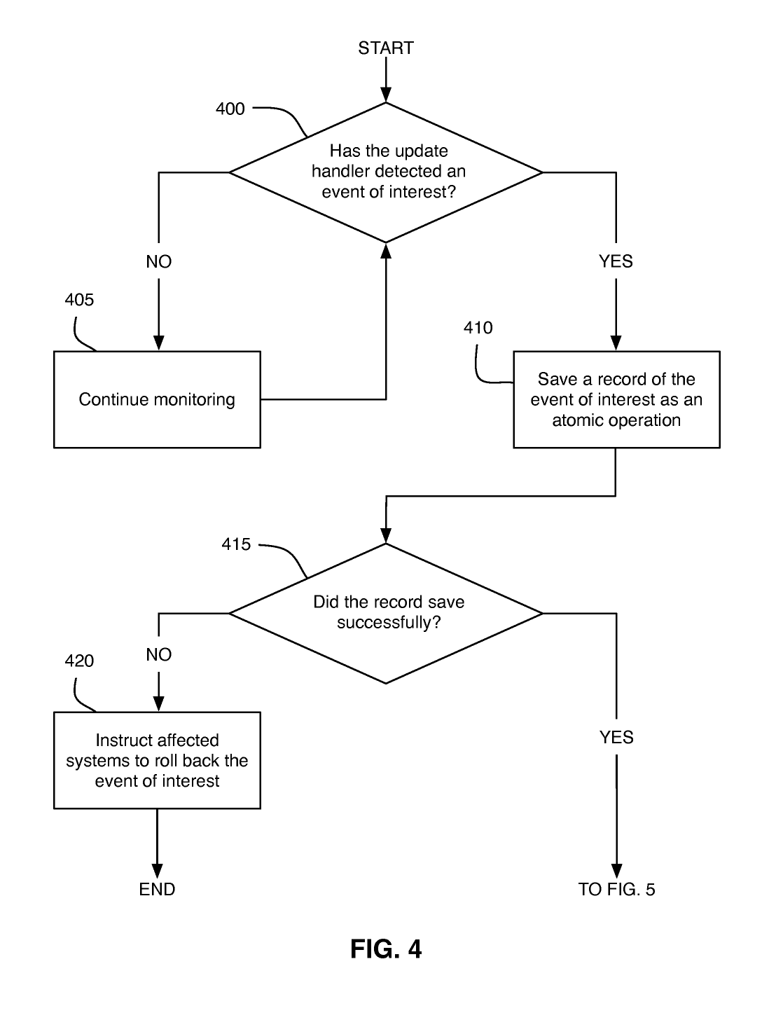

FIG. 4 is a flow-chart representing an example sequence of steps for implementing the intelligent data publishing system 200 of FIG. 2. As described above, the update handler system 205 is tasked with monitoring an administered group of systems for an event of interest. As described above, an event of interest is some computer event that, when detected, requires propagation of information related to it down to a group of heterogeneous external client systems. The update handler system 205 monitors the administered group of systems to determine whether an event of interest has occurred (step 400). If no event of interest is detected, then the update handler system 205 continues monitoring the status of the administered group of systems (step 405).

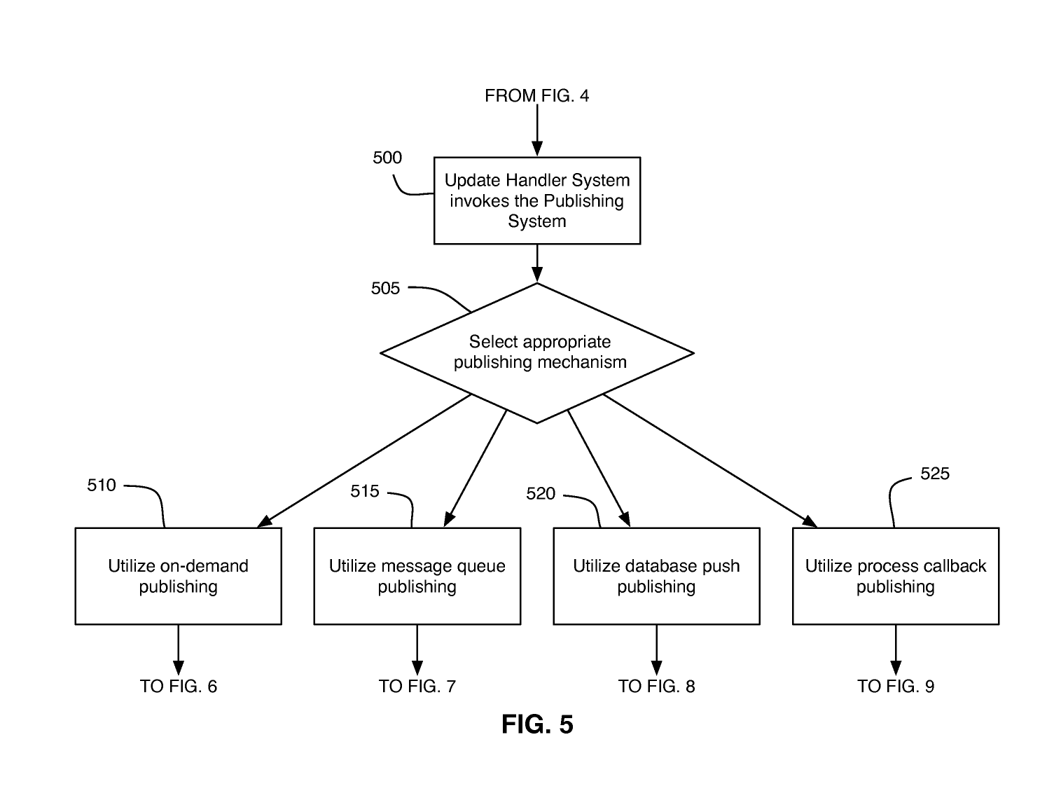

The subsequent steps are then performed atomically (as described above, and in FIG. 3). If an event of interest has occurred, a record of the event of interest is created and saved by the update handler system 205 (step 410). The update handler system then determines whether the record of the event of interest saved successfully (step 415). If the record did not save successfully, then update of the affected external client systems will be impossible. Therefore, systems affected by the event of interest (i.e., those that have already made some state or data change due to the event of interest) are instructed by the update handler system 205 to roll-back to the state before the event of interest occurred (step 420), and the method ends. If the record did save successfully, the method progresses to the steps of FIG. 5.

FIG. 5 is a flow-chart representing a continuing sequence of steps for implementing the intelligent data publishing system 200 of FIG. 2. If the record saved successfully, then the update handler system 205 invokes the publisher/scheduling system 230 to manage the update on the affected external client systems 255-1, 255-2, 255-3, 255-4, 255-5, 255-6, 255-(n-1) and 255-n (step 500). Once invoked, the atomic portion of the process ends. The subsequent process steps are performed non-atomically. The publisher/scheduling system 230 selects the appropriate publishing mechanism to use for the affected external client systems 255-1, 255-2, 255-3, 255-4, 255-5, 255-6, 255-(n-1) and 255-n (step 505), based on the requirements of each external client system, which is known beforehand. In the example, external client systems 255-1, 255-2 and 255-3 utilize on-demand publishing 235, external client system 255-4 utilizes message queue publishing 240, external client systems 255-5 and 255-6 utilize database push publishing 245, and external client systems 255-(n-1) and 255-n utilize process callback publishing 250. Any number of publishing mechanisms may be implemented for the intelligent data publishing system 200. For a fairly homogeneous group of external client systems, only a handful of publishing mechanisms may be required. For more complex clusters of external client systems, more publishing mechanisms may be required.

Once the publisher/scheduling system 230 has selected the appropriate publishing mechanism (or combination of such mechanisms) to use, it invokes the update process using (for example) on-demand publishing 510, message queue publishing 515, database push publishing 520 and/or process callback publishing 525. It is understood that the publishing mechanisms described here are not intended to be limiting, and other publishing mechanisms may be used as appropriate. Additionally, fewer publishing mechanisms may be utilized as well.

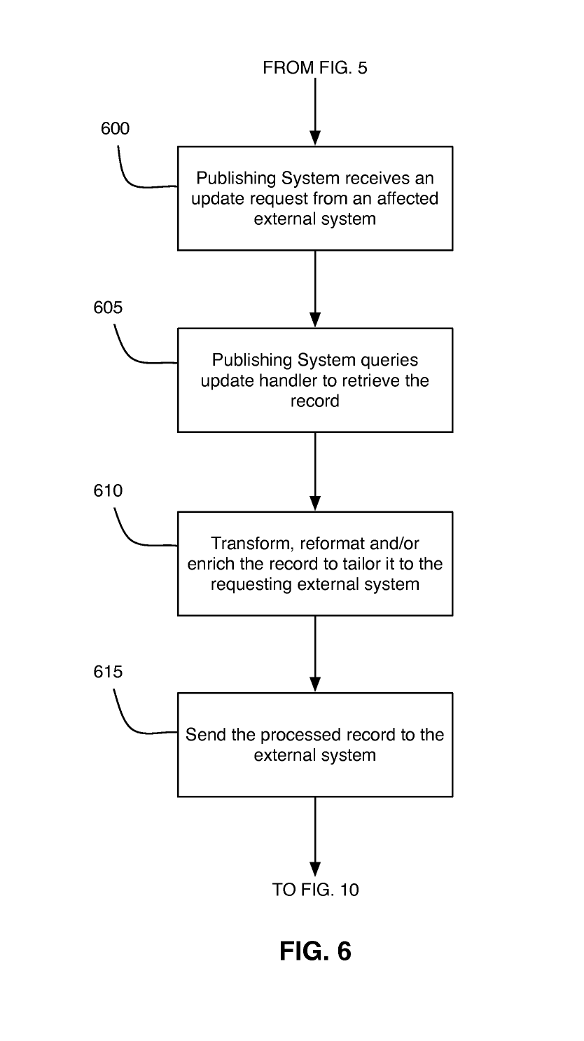

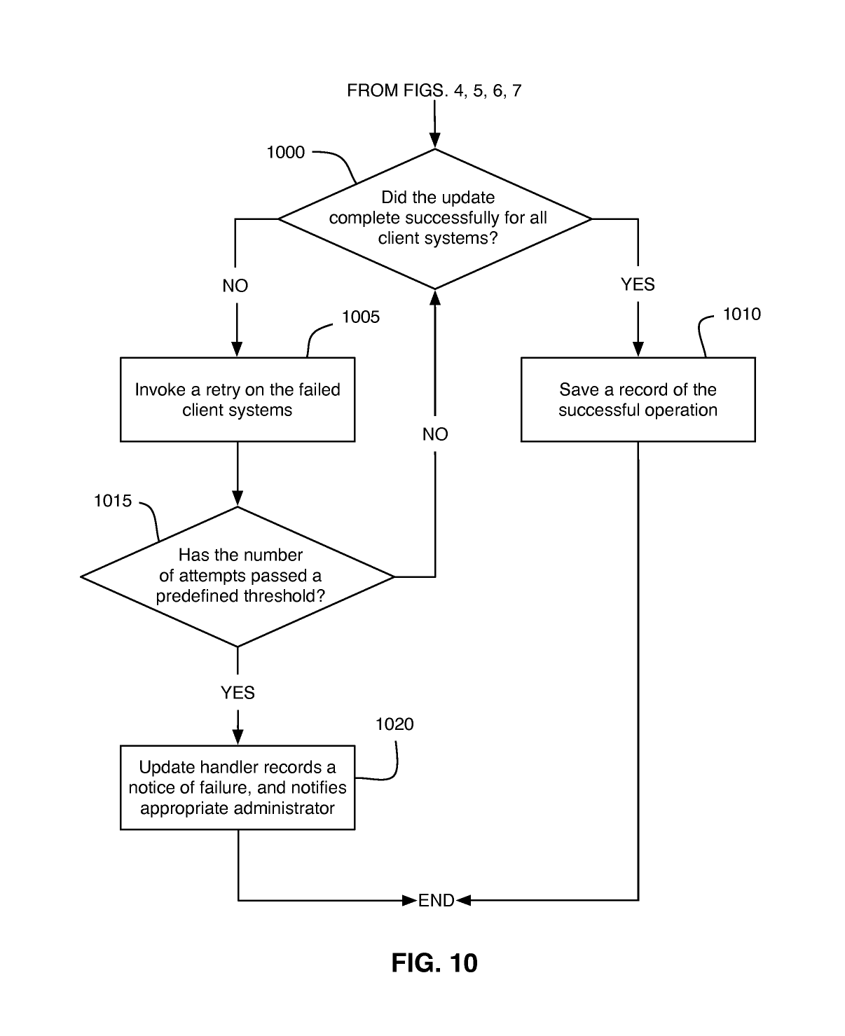

FIG. 6 is a flow-chart representing a continuing sequence of steps for implementing the intelligent data publishing system 200 of FIG. 2, in which the external client systems 255-1, 255-2 and 255-3 are configured such that an on-demand publishing mechanism 510 is used to update the relevant external client systems. With on-demand publishing, updates are triggered when requested by external systems. Therefore, when the publisher/scheduling system 230 is invoked by the update handler 205, the publisher/scheduling system 230 waits for update requests for the affected external client systems 255-1, 255-2, and 255-3. When the publisher/scheduling system 230 receives an update request from each of the affected external client systems 255-1, 255-2, and 255-3 (step 600), the publisher/scheduling system 230 queries the update handler system 205 to retrieve the record of the event of interest (step 605). Subsequently, the record is transformed, reformatted and/or enriched for each of the affected external client systems 255-1, 255-2, and 255-3 (step 610). Finally, the processed record is sent to each affected external client system (or systems) 255-1, 255-2, and 255-3 (step 615). The process then proceeds to the steps of FIG. 10.

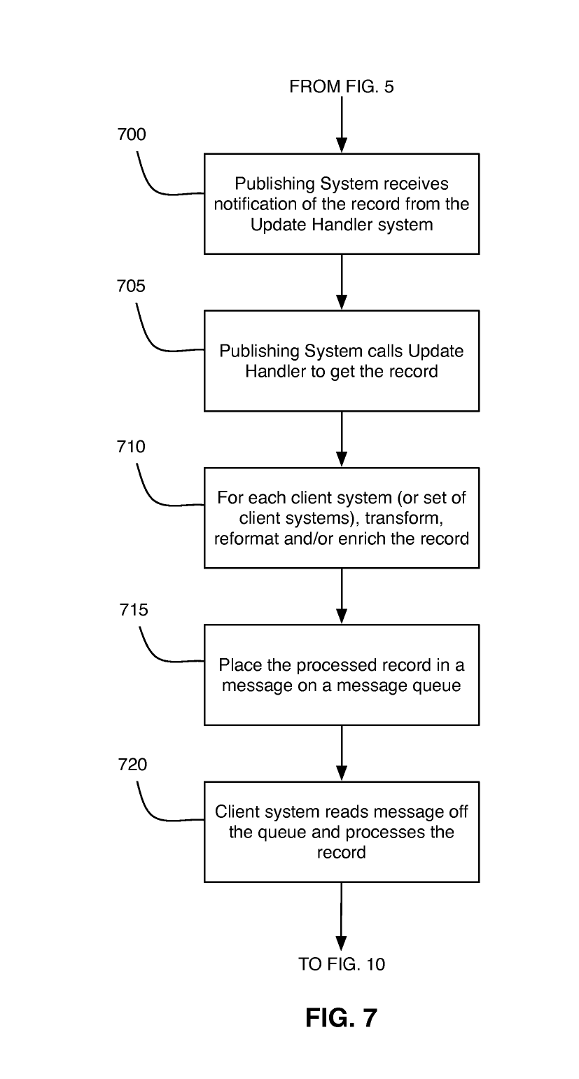

FIG. 7 is a flow-chart representing a continuing sequence of steps for implementing the intelligent data publishing system 200 of FIG. 2, in which at least the external client system 255-4 is configured such that a message queue publishing 515 mechanism is used to update the external client system 255-4. With message queue publishing, update notifications are placed on a message queue where they are to be read by the affected external client system 255-4. Therefore, when the publisher/scheduling system 230 receives notice of the record from the update handler system 205 (step 700), it queries the update handler system 205 to retrieve the record (step 705). Then, the record is transformed, reformatted or otherwise enriched to be compatible and useful to the affected client system 255-4 (or for each client system in a set of affected client systems, if there are more than one) (step 710). The processed record is then attached to a message addressed to the appropriate client systems, and placed on a message queue (step 715). The client system 255-4 (or set of client systems) then reads the message off the queue and processes the attached record (step 720). The process then proceeds to the steps of FIG. 10.

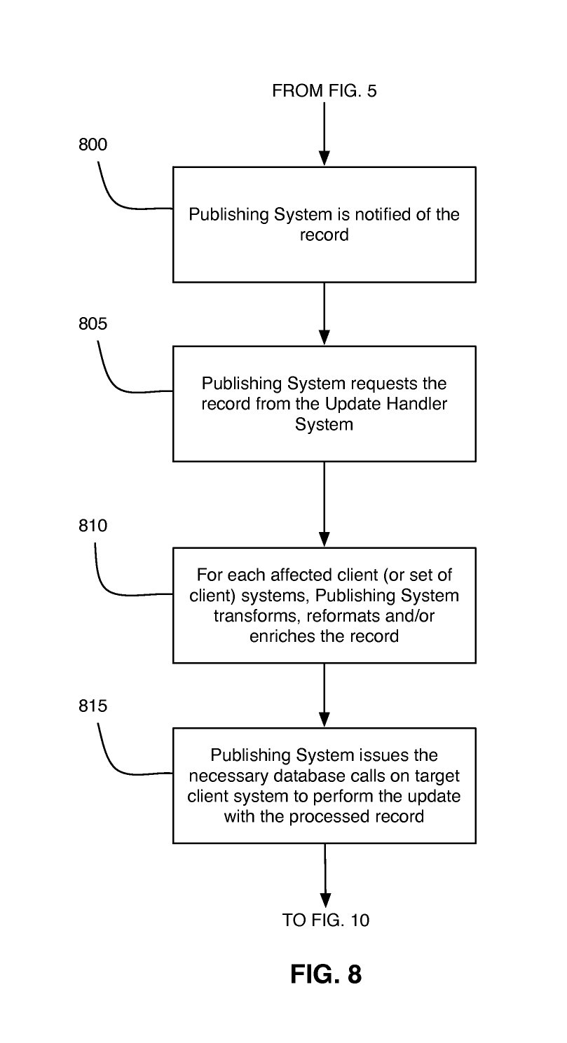

FIG. 8 is a flow-chart representing a continuing sequence of steps for implementing the intelligent data publishing system 200 of FIG. 2, in which at least external client systems 255-5 and 255-6 are configured such that an database push publishing 520 mechanism is used to update the external client systems 255-5 and 255-6. When the publisher/scheduling system 230 is notified of the record of the event of interest (step 800), it requests the record from the update handler system 205 (step 805). Then, for each affected client system 255-5 and 255-6, the publisher/scheduling system 230 transforms, reformats and/or enriches the record (step 810). The publisher/scheduling system then performs the necessary database calls on the appropriate client system (or set of client systems) 255-5 and 255-6 to perform the update using the processed record (step 815). Then process then proceeds to the steps of FIG. 10.

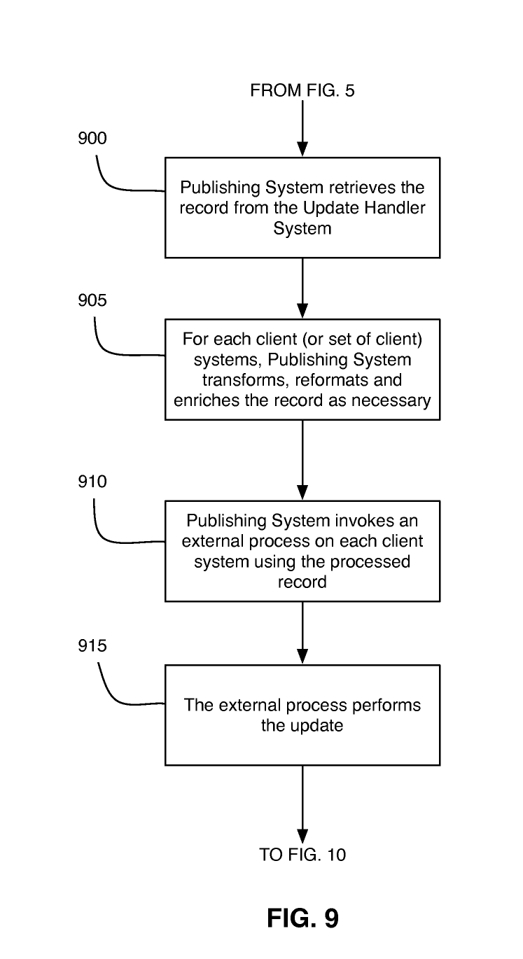

FIG. 9 is a flow-chart representing a continuing sequence of steps for implementing the intelligent data publishing system 200 of FIG. 2, in which the external client systems 255-(n-1) and 255-n are configured such that a process callback publishing 525 mechanism is used to update the external client systems 255-(n-1) and 255-n. Once the publisher/scheduling system 230 has been invoked, it retrieves the record of the event of interest from the update handler system 205 (step 900). Subsequently, for each client system (or set of clients systems) 255-(n-1) and 255-n, the publisher/scheduling system 230 transforms, reformats and/or enriches the record as necessary (step 905). The publisher/scheduling system 235 then invokes an external process on each client system (or set of client systems) 255-(n-1) and 255-n to perform the update using the record (step 910). The external process then initiates the update (step 915). The process then proceeds to the steps of FIG. 10.

FIG. 10 is a flow-chart representing a continuing sequence of steps for implementing the intelligent data publishing system 200 of FIG. 2 after the relevant publishing mechanisms have been invoked (as described above, in FIGS. 6-9). The publisher/scheduling system 230 determines whether the update completed successfully for all client systems (or set of client systems) 255-1, 255-2, 255-3, 255-4, 255-5, 255-6, 255-(n-1) or 255-n (step 900). This may be performed in a variety of ways, depending on, for example, the publishing mechanism used. In message queue publishing, after the update has been attempted on the external client system 255-4, the external client system 255-4 places a message back on the message queue indicating success or failure. The publisher/scheduling system 230 then reads the message off the queue to determine whether the update completed successfully. In database push publishing, the publisher/scheduling system 230 knows immediately whether the update completed successfully, because it issues the database calls directly on the external system 255-5 and 255-6, and immediately receives feedback regarding the subsequent state of the external system 255-5 and 255-6. In process callback publishing, the invoked external process on the external client systems 255-(n-1) and 255-n may each return an indicator to the publisher/scheduling system 230 indicating whether the update was a success. It is understood that the reporting methods used herein are exemplary, and other methods may be used to determine whether the update completed successfully as desired.

If the update did not complete successfully for all client systems (or set of client systems) 255-1, 255-2, 255-3, 255-4, 255-5, 255-6, 255-(n-1) and 255-n, then the publisher/scheduling system 230 invokes a retry for the systems on which the update process failed (step 1005). Subsequently, if the number of attempts passes a predefined threshold (step 1015), then the publisher/scheduling service 230 may notify the update handler 205 that the update process has failed. A notice of failure may be generated, and an appropriate human administrator may be notified of the failure (step 1020).

If the update complete successfully for the client system (or set of client systems) 255-1, 255-2, 255-3, 255-4, 255-5, 255-6, 255-(n-1) and 255-n, then the publisher/scheduling system 230 notifies the update handler 205 of the success, and the update handler saves a record of the successful operation (step 1010).

Software process or processes and executables (such as the update handler system 205 or publisher/scheduling system 230) on the computing system may be used to provide human interfaces (such as a graphical user interface), and to store and initiate computer program instructions used to process and analyze data. Computer program code for carrying out operations described herein may be written in any combination of one or more programming languages, including an object oriented programming language such as Java, C++, C# or the like and conventional procedural programming languages, such as the “C” programming language or similar programming languages. The program code may execute entirely on the computing system, partly on the computing system, as a stand-alone software package, partly on the computing system and partly on a remote computer or server, or entirely on a remote computer or server.

This application was described above with reference to flow chart illustrations and/or block diagrams of methods, apparatus (systems) and computer program products according to one or more embodiments. It is understood that some or all of the blocks of the flow chart illustrations and/or block diagrams, and combinations of blocks in the flow chart illustrations and/or block diagrams, can be implemented by computer program instructions. The computer program instructions may also be loaded onto the computing system to cause a series of operational steps to be performed on the computer to produce a computer implemented process such that the instructions that execute on the computer provide processes for implementing the functions/acts specified in the flowchart and/or block diagram block(s). These computer program instructions may be provided to the CPU 210 of the computing system such that the instructions, which execute via the CPU 210 of the computing system, create means for implementing the functions/acts specified in the flowchart and/or block diagram block(s).

These computer program instructions may also be stored in a computer-readable storage medium 215 that can direct the computing system to function in a particular manner, such that the instructions stored in the computer-readable medium implement the function/act specified in the flowchart and/or block diagram block or blocks. Any combination of one or more computer usable or computer readable medium(s) 215 may be utilized. The computer-usable or computer-readable medium 215 may be, for example (but not limited to), an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory, a read-only memory, an erasable programmable read-only memory (e.g., EPROM or Flash memory), an optical fiber, a portable compact disc read-only memory, an optical storage device, a transmission media such as those supporting the Internet or an intranet, or a magnetic storage device. Any medium 215 suitable for electronically capturing, compiling, interpreting, or otherwise processing in a suitable manner, if necessary, and storing into computer memory may be used. In the context of this disclosure, a computer-usable or computer-readable medium 215 may be any medium that can contain, store, communicate, propagate, or transport the program for use by or in connection with the instruction execution system, apparatus, or device. The computer-usable medium 215 may include a propagated data signal with the computer-usable program code embodied therewith, either in base band or as part of a carrier wave. The computer usable program code may be transmitted using any appropriate medium, including (but not limited to) wireless, wire line, optical fiber cable, RF, etc.

The I/O device(s) 220 permit human interaction with the computer system, such as (but not limited to) a mouse, keyboard and computer display. The I/O device(s) 220 may also include other interactive devices, such as (but not limited to) touch screens, digital stylus, voice input/output, etc.

The network interface device 225 may provide the computing system with connection to a network, which may be a wireless or wired connection to the virtual machine infrastructure. The network 225 may be, for example, the Internet, a corporate intranet, or any other computer network through which a connection to or communication with data publishing system (or other systems) can occur.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A computerized method, comprising:
as an atomic operation,
receiving an action from a source, at a computer, the action resulting in a data state change, the data state change being of a type which must be propagated to multiple heterogeneous computer devices, wherein consistency of data impacted by the data state change is to be maintained among all of the multiple heterogeneous computer devices;
saving a record in storage, associated with the computer, reflecting the data state change, the record containing information usable by at least one update process to update impacted computer devices from among the multiple heterogeneous computer devices to reflect the data state change; and
returning control to the source; and
then, if the atomic operation completes, as a non-atomic operation,
invoking, using the computer, the at least one update process to perform
modifying of the data into a configuration for compatibility with the impacted computer devices based upon contents of the record,
updating of the impacted computer devices with the modified data using a publishing mechanism, and
receiving from the publishing mechanism, for each of the impacted computer devices, an indicator of whether the updating succeeded or failed, and
if the updating failed, initiating a retry of the updating using the publishing mechanism, and
if all the updating of all of the impacted computer devices succeeded, ending the non-atomic operation.

2. The method of claim 1, wherein the updating the impacted computer devices with the modified data using the publishing mechanism comprises:
invoking an on-demand publishing mechanism.

3. The method of claim 2, wherein the performing by the at least one update process includes encrypting the modified data.

4. The method of claim 1, wherein the updating the impacted computer devices with the modified data using the publishing mechanism comprises:
invoking a message queue publishing mechanism.

5. The method of claim 4, wherein the performing by the at least one update process includes encrypting the modified data.

6. The method of claim 1, wherein the updating the impacted computer devices with the modified data using the publishing mechanism comprises:
invoking a push-type publishing mechanism.

7. The method of claim 6, wherein the performing by the at least one update process includes encrypting the modified data.

8. The method of claim 1, wherein the updating the impacted computer devices with the modified data using the publishing mechanism comprises:
invoking a process callback publishing mechanism.

9. The method of claim 8, wherein the performing by the at least one update process includes encrypting the modified data.

10. The method of claim 1, wherein the modifying of the data comprises at least one of:
transforming, reformatting or enriching the data with additional information.

11. The method of claim 1, further comprising logging the indicator of whether the update succeeded or failed.

12. The method of claim 1, wherein the updating the impacted computer devices with the modified data using the publishing mechanism comprises:
invoking a non-duplicative combination of at least two of:
(i) an on-demand publishing mechanism,
(ii) a message queue publishing mechanism,
(iii) a push-type publishing mechanism, or
(iv) a process callback publishing mechanism.

13. The method of claim 12, wherein the invoking the at least one update process to perform the modifying of the data comprises retrieving the data impacted by the data state change from the record.

14. The method of claim 13, wherein the invoking the at least one update process comprises:
asynchronously calling a publishing service including the publishing mechanism.

15. The method of claim 1, further comprising monitoring status of the atomic operation.

16. The method of claim 1, further comprising monitoring status of the non-atomic operation.

17. The method of claim 1, wherein the invoking the at least one update process comprises:
asynchronously calling a publishing service including the publishing mechanism.
